(19) United States
(12) Patent Application Publication
(10) Pub. No.: US 2015/0156296 A1
(43) Pub. Date: Jun. 4, 2015

(54) Device Holder with Button locking Mechanism

(71) Applicant: David Soofian, New York, NY (US)

(72) Inventor: David Soofian, New York, NY (US)

(21) Appl. No.: 14/093,513

(22) Filed: Dec. 1, 2013

(51) Int. Cl. H04M 1/04; H04M 1/02

(52) U.S. Cl. CPC H04M 1/04; H04M 1/0202

(57) ABSTRACT

An apparatus for securing an electronic device using, in part, at least one pressable button on the device. A user can slide an electronic device into the apparatus. As the device moves into the apparatus, at least one button on a side of the device enters the locking mechanism where a first section stops the device from sliding further into the apparatus. A second section may stop the device from sliding out in the other direction.

### CROSS-REFERENCE TO RELATED APPLICATIONS

Not applicable.

### STATEMENT CONCERNING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The present invention relates to a method and apparatus for securing an electronic device using at least one of its buttons.

Smart phones have become mobile computers, which are relied upon for both audio and digital communication. To make these devices more readily accessible to users, various contraptions have been devised. For instance, many users place their smartphones in specialized armbands to use during exercise. These armbands have a fully enclosed pouch into which the smartphone is placed. One side of the pouch is made of clear plastic that allows the user to interact with the touchscreen on his/her device through the clear plastic.

However, there are disadvantages to these armbands that make them unsuitable for casual use. A first disadvantage is that the smartphone is fully encased in the pouch, making the smartphone hard to remove if the user wants full access to his/her device. A second disadvantage is that because the smartphone is fully encased, the entire mechanism is unnecessarily bulky. A third disadvantage is that because the smartphone is placed on the arm, it is difficult and cumbersome to access for regular use.

### BRIEF SUMMARY OF THE INVENTION

The present invention avoids the pitfalls of the prior art by affixing a device to a strap using a tray that completely secures the device in the upward/downward, left/right and backward directions, and only partially secures the device in the forward direction, such that the device can slide in and out from the front of the tray for easy engagement and disengagement of the device.

In a preferred embodiment, the present invention provides a tray with a novel locking mechanism that uses the device's button(s) to secure the device in the forward/backward directions. The locking mechanism is built into a sidewall of the tray and includes at least one sloped region, a recess and one wall. As the device is pushed into the tray, its protruding button(s) enters a recess. In the backward direction of this recess is a wall that stops the protruding button(s) from travelling further in the backward direction. In the forward direction of this recess is a sloped region that causes the button(s) to be pushed into the device as the device is pulled out of the tray. The force exerted by the button(s) onto this slope helps to secure the device in the forward direction and allows a user to disengage the device by exerting sufficient force to overcome this pressure.

In another preferred embodiment, the present invention provides a tray with the locking mechanism described above, that uses the phone's buttons to secure the device in the backward direction, and uses the additional pressure/friction caused by the tightness of the tray around the device to partially secure the device in the forward direction. The tray is composed of a floor that covers at least a part of the back of the device, sidewalls that at least partially cover the sides of the device, and lips that extend from the sidewalls such that they only partially cover the front of the device and do not interfere with the use of the input and display components on the device's face. The tray is measured such that the device can fit within the tray, but that the tray exerts sufficient pressure on the device to keep the device secure in the forward direction.

In yet another preferred embodiment, the present invention provides a strap that is secured to the tray, so that the tray can be strapped onto a user's wrist. By strapping the tray of the present invention onto a user's wrist, the present invention enables the user to wear his/her device like a wristwatch. When worn, a user is able to easily glance at his/her device to view the screen, use his/her device while strapped to the user's wrist, and to easily remove the device from the tray by pulling the device with sufficient force.

### BRIEF DESCRIPTION OF THE SEVERAL VIEWS OF THE DRAWING

FIG. 1 is an aerial perspective of the prior art.

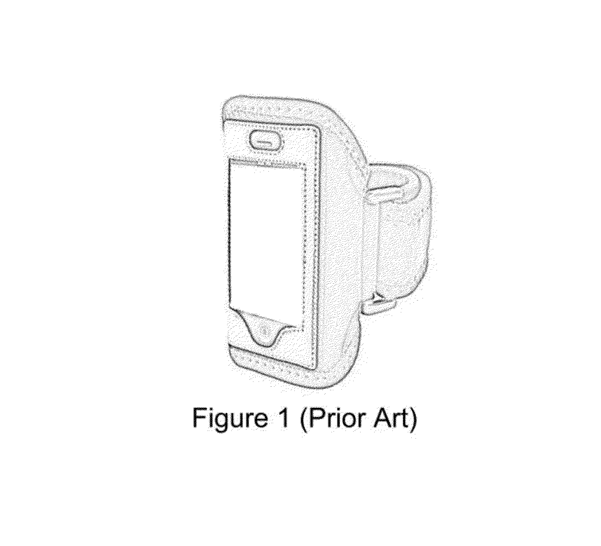

FIG. 2 is an aerial perspective of one embodiment of the present invention.

FIG. 3 is an aerial perspective of one embodiment of the present invention with a device secured.

FIG. 4A is a geometric view of a button of a device as the button engages a first sloped section of the locking mechanism in a preferred embodiment of the present invention.

FIG. 4B is a geometric view of a button of a device as the button engages a second sloped section of the locking mechanism in a preferred embodiment of the present invention.

FIG. 4C is a geometric view of a button of a device as the button engages a third sloped section of the locking mechanism in a preferred embodiment of the present invention.

FIG. 5 is a perspective of the underside of one embodiment of the present invention.

### DETAILED DESCRIPTION OF THE INVENTION

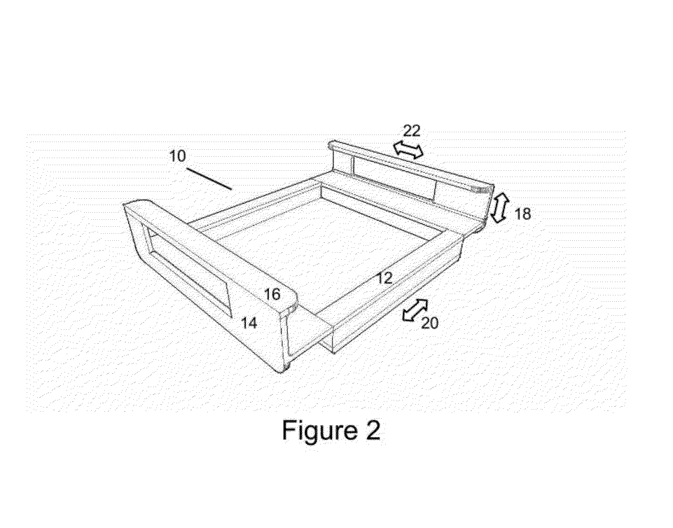

FIG. 2 is an aerial perspective of one embodiment of the present invention. The invention comprises of a floor 12 with sidewalls 14 extending therefrom, and a lip 16 extending from each sidewall 14. The floor 12 and sidewalls 14 are sized and arranged such that they substantially match the size and shape of a cross-section of the device to be secured. Specifically, the width of the floor 12 should substantially match the width of the device and the height of the sidewalls 14 should substantially match the depth of the device. Each sidewall 14 has a lip 16 that extends from the edge of the sidewall 14 towards the center of the device. The length of each lip 16 is long enough to reliably secure the device without obstructing the active portion of the device, which in most cases is a large, touch-enabled screen. Together, the floor 12, sidewalls 14 and lips 16 create a tray 10 to secure the device in the upward/downward 18 and left/right directions 20.

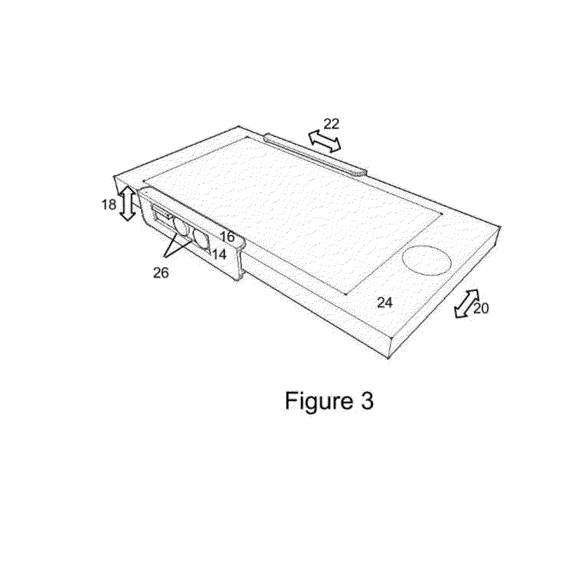

FIG. 3 is an aerial perspective of one embodiment of the present invention with a device secured. The present invention seeks to secure the device 24 along at least 3 degrees of freedom—forward/backward 22, upward/downward 18 and left/right 20. The combination of the floor 12 and the lips 16 secures the device in the upward/downward direction 18. The sidewalls 14 secure the device in the left/right direction 20.

The device 24 is partially secured in the forward/backward direction 22 using pressure and friction. In measuring the exact width of the floor 12 and height of the sidewalls 14, it is preferable that the width of the floor 12 (the distance between the sidewalls 14) be calculated such that the sidewalls 14 touch and put pressure on the sides of the device 24 to be secured. Similarly, it is preferable that the height of the sidewalls 14 (the distance between the floor 12 and the lips 16) be calculated such that the floor 12 and lips 16 touch and put pressure on the front and back of the device 24 to be secured. In this way, the pressure put on the device 24, and the associated friction it creates, can operate to secure the device in the forward/backward direction 22.

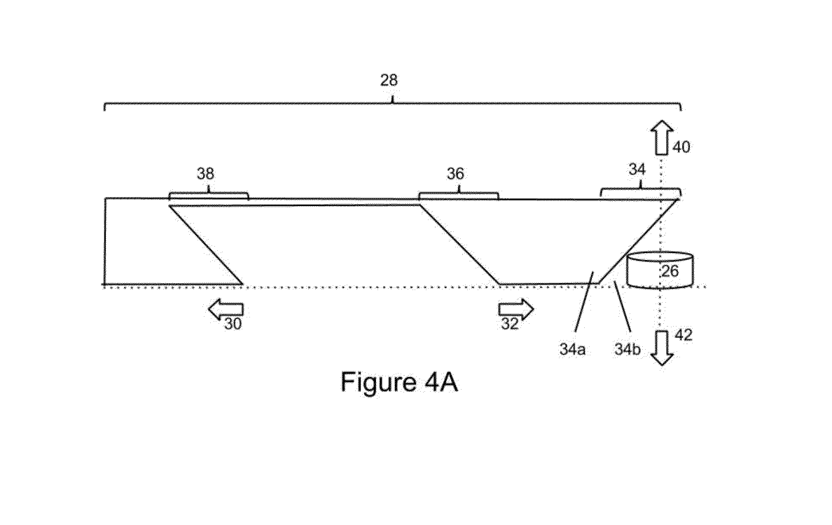

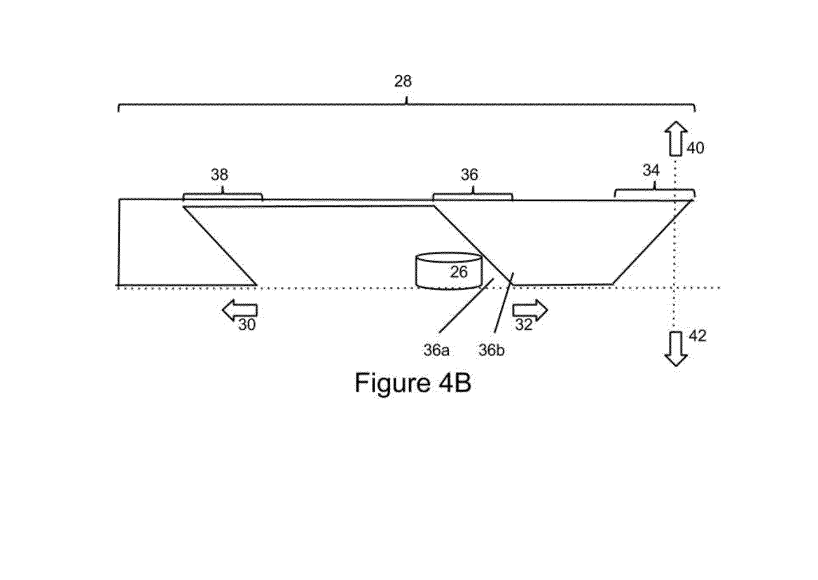

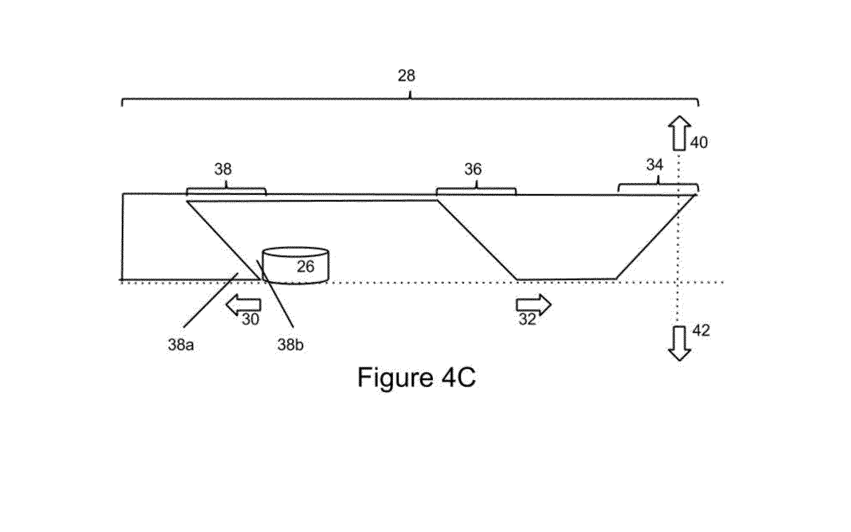

FIGS. 4A-C are geometric views of a button of a device as the button engages a locking mechanism of the present invention. The locking mechanism 28 is located within a sidewall 14 of the tray 10. The locking mechanism 28 secures the device 24 in the backward direction 30 and partially secures the device in the forward direction 32 so that the device 24 can be removed. The below discussion describes a preferred embodiment of the locking mechanism 28 of the present invention in relation to FIGS. 4A-C as the device engages the tray 10 (pushed from right to left in FIGS. 4A-C).

FIG. 4A is a geometric view of a button of the device as the button engages a first sloped section of the locking mechanism in a preferred embodiment of the present invention. A user slides the device 24 into the tray 10 from the front section thereof in the backward direction 30. The device 24 has at least one button 26 that protrudes from at least one of its sides. As the button 26 reaches the front end of the tray 10, the button comes into contact with a first sloped section 34 of the locking mechanism 28. This first sloped section 34 is defined by an obtuse inner sidewall angle 34a facing the rear of the tray and an acute opening angle 34b facing the front of the tray. As the button 26 is pushed backwards 30 and into contact with the first sloped section 34, a force is exerted downwards 42 so that the button is pressed into the device 24. Thus, the first sloped section 34 allows the button 26 to be received into the tray 10.

FIG. 4B is a geometric view of a button of the device as the button engages a second sloped section of the locking mechanism in a preferred embodiment of the present invention. As the device 24 is pushed further backward 30 into the tray 10, the depressed button 26 is pushed into contact with a second sloped section 36 of the locking mechanism 28. This second sloped section 36 is defined by an obtuse inner sidewall angle 36b facing the front of the tray 10 and an acute opening angle 36a facing the rear of the tray 10. As the button 26 is pushed further backward 30 and into contact with the second sloped section 36, a springing force within the button 26 (that causes the button 26 to return to its normal position after a usual depression by a user) exerts a force in the upward direction 40 so that the button is pushed back out and protrudes from the device 24.

FIG. 4C is a geometric view of a button of the device as the button engages a third sloped section of the locking mechanism in a preferred embodiment of the present invention. As the device 24 is pushed further backward 30 into the tray 10, the protruding button 26 is pushed into contact with a third sloped section 38 of the locking mechanism 28. This third sloping section 38 is defined by an acute inner sidewall angle 38a facing the rear of the tray 10 and an obtuse opening angle 38b facing the front of the tray 10. As the protruding button 26 is pushed further backward 30 and into contact with the third sloped section 38 of the sidewall 14, it is stopped by this third sloped section 38 from proceeding further, blocking the device 24 from any further movement in the backward direction 30. In an alternate embodiment, the third section 38 may be a wall that is defined by an inner sidewall angle 38a that can be up to 90 degrees.

As described above, the locking mechanism 28 also partially secures the device 24 in the forward direction 32. The below discussion describes a preferred embodiment of the locking mechanism 28 of the present invention in relation to FIG. 4B wherein a device 24 is partially secured in the forward direction 32.

FIG. 4B is a geometric view of a button of the device as it engages a second sloped section of the locking mechanism in a preferred embodiment of the present invention. When the device 24 is fully inserted into the tray 10, a button 26 comes into contact with the second sloped section 36 of the locking mechanism 28. This second sloped section 36 is defined by an obtuse inner sidewall angle 36b facing the front of the tray and an acute opening angle 36a facing the rear of the tray 10. The second sloped section 36 defines the amount of force that can be exerted in the forward direction 32 before the device 24 will disengage from the locking mechanism 28. This threshold of force can be calculated as the force needed to push down 42 the button 26, divided by the tangent of the acute opening angle 36a facing the rear of the tray 10 that defines the second sloped section 36. Thus, the threshold at which the device 24 is secured in the forward direction 32 is defined by the angle of the second sloped section 36.

As described above, the locking mechanism 28 also allows the device 24 to be easily disengaged from the locking mechanism 28. The below discussion describes a preferred embodiment of the locking mechanism 28 of the present invention in relation to FIGS. 4A-B as a device 24 is disengaged from the tray 10 (pulled from left to right in FIGS. 4A-C).

FIG. 4B is a geometric view of a button of the device as the button engages a second sloped section of the locking mechanism in a preferred embodiment of the present invention. As the device 24 is pulled out from the tray 10 in the forward direction 32, a button 26 comes into contact with the second sloped section 36 of the locking mechanism 28. Assuming the device 24 is pulled in the forward direction 32 with a force equal to or greater than the threshold force defined above, the button 26 will be pushed downward 42 and into the device 24.

FIG. 4A is a geometric view of a button of a device as it engages a first sloped section of the locking mechanism in a preferred embodiment of the present invention. As the device 24 is pulled further out of the tray 10 in the forward direction 32, the depressed button 26 is pushed into contact with a first sloped section 34 of the locking mechanism 28 and a springing force within the button 26 (that causes the button 26 to return to its normal position after a usual depression by a user) exerts an upwards 40 force so that the button 26 is pushed back out and protrudes from the device 24.

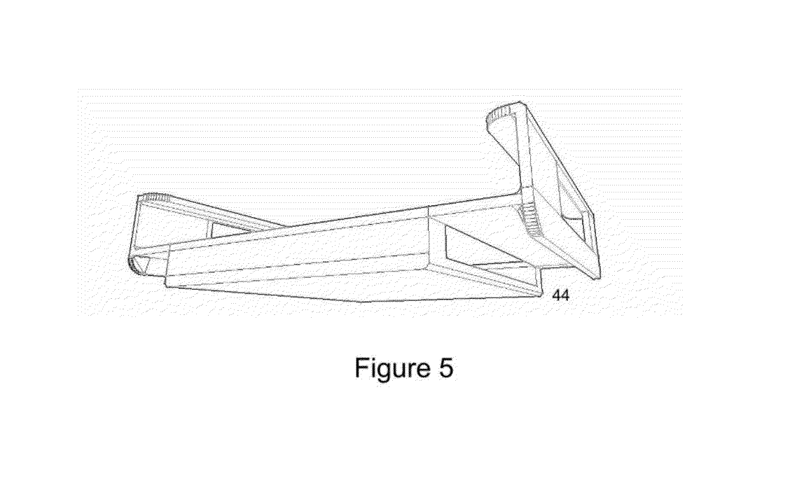

FIG. 5 is a perspective of the underside of one embodiment of the present invention. The tray 10 may be secured to a strap in many ways, as would be obvious to one of ordinary skill in the art. In a preferred embodiment, the tray 10 is secured to a strap by a loop 44 on the underside of the tray 10. The loop 44 is preferably the size of a wrist, so that the loop 44 can lie flat on a wearer's wrist and stop the band from exerting pressure on the upper corners of the wearer's wrist.

As illustrated and explained above, in a primary embodiment, the present invention provides a specialized tray that completely secures a device in two and a half degrees of freedom—upward/downward, left/right and backwards—by at least partially encasing the rear, sides and top the device and using the buttons that protrude from the device to stop the device from moving in the backward direction. In addition, in a primary embodiment, the present invention utilizes both the pressure exerted by the tray onto the device and the force needed to push down the device's button(s) in order to secure the device in the forward direction. These combined forces act to stop the device from inadvertently disengaging from the tray during normal wear. However, these forces are relatively easy for the user to overcome when purposefully attempting to disengage the device from the tray.

By securing the tray of the present invention to a band or strap, the device can be worn by a user in an everyday context. The device can be inserted into the wearable tray in a single motion, from front to back. When the buttons on the device are completely inserted into the tray's locking mechanism, the user will feel that the device has been halted and understand that the device is now completely inserted into the tray and secure. The locking mechanism and pressure from the tray will keep the device secure during normal use. Because the tray does not cover the touch-enabled display of the device, the device can be operated fully while worn using the present invention. For instance, a user can use his/her smartphone as a watch and/or view notifications on his/her smartphone.

The user can also easily disengage the device in order to use it device with two hands by pulling the device towards the front of the tray—the opposite motion that the user used to slide the device into the tray. The user need only exert sufficient force to overcome the pressure exerted by the tray and the additional force exerted by the device's button(s) to remove the device from the tray.

1. An apparatus for securing an electronic device comprising:
a floor that covers at least a portion of a first side of a device to be secured, wherein said device has at least one button protruding therefrom;
a first sidewall that extends from said floor and covers at least a portion of a second side of said device;
a second sidewall that extends from said floor and covers at least a portion of a third side of said device, wherein said first and second sidewall are parallel to each other and wherein said second sidewall includes a locking mechanism for securing said device from moving in a first direction parallel to said sidewalls, said locking mechanism comprising:
a recess that can accommodate said button; and
a first edge of said recess that is defined by an acute or a right inner wall angle, such that when said button comes into contact with said first edge said device is secured from moving in a said direction parallel to said sidewalls; and
lips that extend from said first and second sidewalls.

2. The apparatus according to claim 1, wherein said locking mechanism further comprises of a second edge of said recess that is defined by an inner wall angle that is obtuse, such that when said button comes into contact with said second edge said device is partially secured from moving in a second direction parallel to said sidewalls.

3. The apparatus according to claim 2, wherein said second edge causes said button to be pressed into said device when said device is pulled by a user in said second direction.

4. The apparatus according to claim 1, wherein said device is secured into said apparatus by a user sliding said device into said apparatus in said first direction.

5. The apparatus according to claim 1, wherein said lips extend minimally over a face of said device such that said lips do not obstruct the use of a display or any input mechanisms on said first side of said device.

6. The apparatus according to claim 1, wherein only two sidewalls extend from said floor.

7. The apparatus according to claim 1, further comprising a strap that can be secured onto a user's body.

8. A method of securing an electronic device comprising the steps of:
sliding a device in a first direction into a tray that covers a portion of a device to be secured, wherein said device has at least one button protruding therefrom;
receiving said button into a locking portion of said tray, wherein said button enters a recess within said locking portion; and
blocking said device from sliding further into said tray in said first direction when said button comes into contact with a blocking section of said locking portion that is defined by an acute or right inner wall angle.

9. The method of claim 8, further comprising the step of partially blocking said device from sliding out of said tray in a second direction when said button comes into contact with a second blocking section of said locking portion that is defined by an obtuse inner wall angle.

10. The method of claim 9, further comprising the step of sliding said device out of said tray in said second direction, wherein said button engages said second blocking section and is pressed into said device as it is removed from said tray.
